(19) United States
(12) Patent Application Publication
(10) Pub. No.: US 2022/0027814 A1
(43) Pub. Date: Jan. 27, 2022

(54) ENVIRONMENTAL, SOCIAL, AND GOVERNANCE (ESG) PERFORMANCE TRENDS

(71) Applicant: Rockefeller & Co. LLC, New York, NY (US)

(72) Inventors: Harshad Lalit, Jersey City, NJ (US); Casey Collins Clark, New York, NY (US)

(21) Appl. No.: 17/386,057

(22) Filed: Jul. 27, 2021

Related U.S. Application Data
(60) Provisional application No. 63/057,221, filed on Jul. 27, 2020.

(51) Int. Cl. G06Q 10/06

(52) U.S. Cl. CPC G06Q 10/0639

(57) ABSTRACT

Data from a variety of sources are synthesized into a score for performance on environmental, social, and governance issues. Evaluating companies to obtain an objective, quantitative score in this manner can facilitate the identification of undervalued companies and otherwise support investment activity based on a synthesized, dynamic measure of ESG performance.

### CROSS-REFERENCE TO RELATED APPLICATIONS

This application claims priority to U.S. Provisional Patent Application No. 63/057,221 filed on Jul. 27, 2020, where the entire contents of which is hereby incorporated by reference.

### TECHNICAL FIELD

This disclosure generally relates to techniques for objectively scoring companies on a combination of environmental, social, and governance matters in a manner that permits side-by-side comparison across industries and over time.

### BACKGROUND

A wide range of non-financial issues may affect the current value and expected future value of a company. This includes environmental, social, and governance (“ESG”) matters. While a number of funds have emerged to capture these investment themes, there remains a need for tools and techniques to objectively measure improvement in ESG performance over time.

### SUMMARY

Data from a variety of sources are synthesized into a score for performance on environmental, social, and governance (ESG) issues. Evaluating companies to obtain an objective, quantitative score in this manner can facilitate the identification of undervalued companies and otherwise support investment activity based on a synthesized, dynamic measure of ESG performance.

In an aspect, a computer program product disclosed herein may include computer executable code embodied in a non-transitory computer readable medium that, when executing on one or more computing devices, performs the steps of: selecting a number of objective metrics for creating a score to evaluate a company on environmental, social, and governance issues based on a materiality map that identifies one or more environmental, social, and governance issues relevant to an industry for the company; obtaining historical data for the number of objective metrics from one or more commercial data providers; calculating the score at a number of different times based on the historical data, where calculating the score includes normalizing all of the objective metrics to be a figure of merit positively correlated to more favorable performance in the industry for the company; measuring a change in the score over time; and applying the change as a factor in making a decision to purchase or sell shares in the company.

Implementations may include one or more of the following features. Applying the change may include using the change as a factor in a factor-based investment in the company. Applying the change may include using the change as a selection criterion for the company in a portfolio. Applying the change may include weighting the company in a portfolio based on the change. The computer program product may further include code that, when executed, performs the step of displaying the change to a user on a display.

In an aspect, a method disclosed herein may include: selecting a number of objective metrics for creating a score to evaluate a company on environmental, social, and governance issues; calculating the score at a number of different times; measuring a change in the score over time; and applying the change includes using the change as a factor in a factor-based investment in the company.

Implementations may include one or more of the following features. Applying the change as a factor may include using the change as a selection criterion for the company in a portfolio. Applying the change as a factor may include weighting the company in a portfolio based on the change. Applying the change as a factor may include identifying the company as undervalued or overvalued based on the change in the score over time. Applying the change as a factor may include making a decision to purchase or sell shares in the company based on the change. Applying the change as a factor may include providing the change as an input to a programmatic stock purchasing engine. The method may further include displaying the change to a user as one or more of a quantity and a graph. The method may further include displaying the change to a user in manner that compares the change to a second change calculated for one or more other companies. The number of objective metrics may be selected from among objective metrics with historical data available from one or more commercial data providers. Selecting the number of objective metrics may include creating a materiality map that identifies one or more environmental, social, and governance issues relevant to an industry for the company. Calculating the score may include obtaining historical data for the number of objective metrics and imputing values for one or more of the number of objective metrics. Calculating the score may include scaling one or more of the objective metrics in the score based on a revenue of the company. Calculating the score may include normalizing all of the objective metrics to be a figure of merit positively correlated to more favorable performance. Calculating the score may include weighting one or more of the objective metrics in the score according to a measured relevance of the one or more of the objective metrics to a financial performance within a peer group of companies including the company.

In an aspect, a system disclosed herein may include: a memory storing a materiality map that identifies one or more environmental, social, and governance issues relevant to an industry; a server configured to acquire historical data for one or more objective metrics measuring the one or more environmental, social, and governance issues; and a scoring engine executing on the server, the scoring engine configured to calculate a score to evaluate a company in the industry on the one or more environmental, social, and governance issues by calculating a score at a number of different times based on the historical data, to measure a change in the score over time, and to apply the change as a factor in a factor-based investment in the company.

Implementations may include one or more of the following features. The scoring engine may be configured to apply the change by displaying a factor-based analysis to a user. The scoring engine may be configured to apply the change by automatically initiating a purchase or sale of stock in the company.

### BRIEF DESCRIPTION OF THE DRAWINGS

The foregoing and other objects, features and advantages of the devices, systems, and methods described herein will be apparent from the following description of particular embodiments thereof, as illustrated in the accompanying drawings. The drawings are not necessarily to scale, emphasis instead being placed upon illustrating the principles of the devices, systems, and methods described herein. In the drawings, like reference numerals generally identify corresponding elements.

FIG. 1 illustrates a method for environmental, social, and governance (ESG) scoring.

FIG. 2 illustrates a process for scoring greenhouse gas emissions.

FIG. 3 illustrates a process for scoring gender equality.

FIG. 4 shows a distribution of ESG scores that has been adjusted to account for outliers.

FIG. 5 illustrates a universe of undervalued companies based on improvements in ESG scoring.

FIG. 6 illustrates ten year performance of a top quintile of ESG improvers relative to a commercial market index.

FIG. 7 illustrates a materiality map.

FIG. 8 shows a system for evaluating ESG trends.

FIG. 9 shows a computing device for use in the system of FIG. 8.

FIG. 10 shows a method for evaluating ESG performance trends.

### DETAILED DESCRIPTION

Embodiments will now be described with reference to the accompanying figures. The foregoing may, however, be embodied in many different forms and should not be construed as limited to the illustrated embodiments set forth herein.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, for example, the term “or” should generally be understood to mean “and/or.”

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately” or the like, when accompanying a numerical value, are to be construed as indicating a deviation as would be appreciated by one of ordinary skill in the art to operate satisfactorily for an intended purpose. Similarly, words of approximation such as “approximately” or “substantially” when used in reference to physical characteristics, should be understood to contemplate a range of deviations that would be appreciated by one of ordinary skill in the art to operate satisfactorily for a corresponding use, function, purpose, or the like. Ranges of values and/or numeric values are provided herein as examples only, and do not constitute a limitation on the scope of the described embodiments. Where ranges of values are provided, they are also intended to include each value within the range as if set forth individually, unless expressly stated to the contrary. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

In the following description, it is understood that terms such as “first,” “second,” “top,” “bottom,” “up,” “down,” and the like, are words of convenience and are not to be construed as limiting terms unless specifically stated to the contrary.

The following description generally sets forth techniques for environmental, social, and governance (ESG) scoring. It will be understood that the following method is provided by way of example only, and is not intended to limit the scope of this disclosure. The steps may be excluded or varied, or other steps included consistent with the methods and systems described herein.

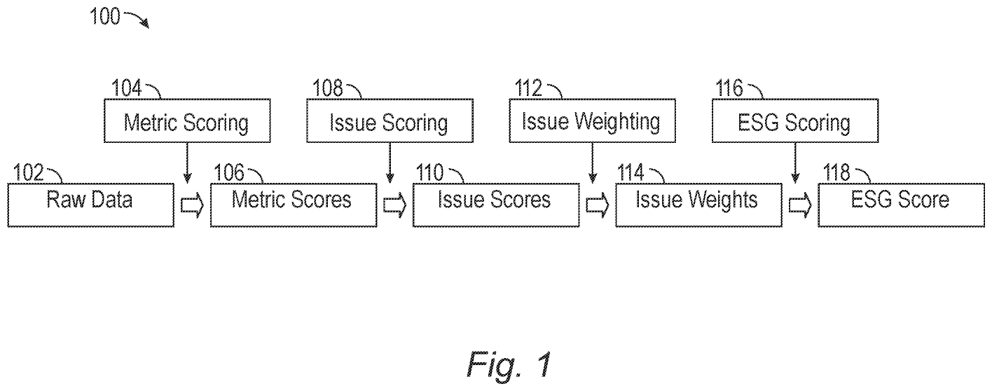

FIG. 1 illustrates a method for ESG scoring as described herein. This technique may be used, for example, to identify improving trends in objectively measured ESG performance. As illustrated in FIG. 1, the method 100 for scoring may generally include metric scoring, issue scoring, issue weighting, and ESG scoring, where each is described in greater detail below.

In general, raw data 102 may be obtained for a company of interest. The relevant raw data 102 may vary from industry to industry and segment to segment. The raw data 102 for a particular company may be selected using ESG issues identified in a materiality map, and derived from any of a variety of data sources that provide supporting, related data, which may in turn be filtered, augmented, or otherwise pre-processed for consistency and continuity of data. Additional details of a process for identifying, obtaining, and pre-processing raw data 102 are provided below with reference to the description of a materiality map.

Once raw data 102 is obtained, metric scoring 104 may be performed on this raw data 102 by generating metric scores, e.g., on a scale from 0-100 (where 0 indicates worst and 100 indicates best) or any other suitable scale that provides an objective measure of performance and a consistent basis for comparison to other objective metrics. In the raw data 102, variables may follow different directions of performance. In general, such data can be reinterpreted as figures of merit where a greater numerical value represents a more favorable performance on the corresponding issue or metric. For example, for a percentage of renewable energy use, a higher percentage is generally more favorable. In these cases, the direction of company performance in the raw data may be directionally aligned with the final score (or for a percentage, still more directly aligned numerically with the objective metric score). However, this is not the case for all variables. For some raw data 102, a lower observed value reflects better performance. As an example, for greenhouse gas emissions, a lower numerical value is generally better. For a metric such as gender equality, a number closer to a population gender metric or other indicia of gender equality may indicate better company performance, with a number closer to the value of perfect gender equality indicating better company performance. In other cases, there may be a non-linear relationship, e.g., a logarithmic, parabolic, sinusoidal, or other relationship, between values in the raw data 102 and a linear scale for the objective metric. These various cases may advantageously be pre-processed into monotonically and/or linearly increasing figures of merit as the underlying values indicate better company performance. By pre-processing individual metrics in this manner, a suite of metrics may more easily and consistently be combined into an aggregated ESG score to facilitate timewise analysis for individual companies and side-by-side comparison among companies. A number of such conversions are now discussed in greater detail.

For metrics where a lower is better, the distribution of the data may be flipped by making the original max(min) the new min(max), while leaving the distance between any two data points unchanged. At each point in time, this is achieved by creating a new metric that is the distance between the observed max and the observed metric values:

New(X)=max(X)−X [Eq. 1]

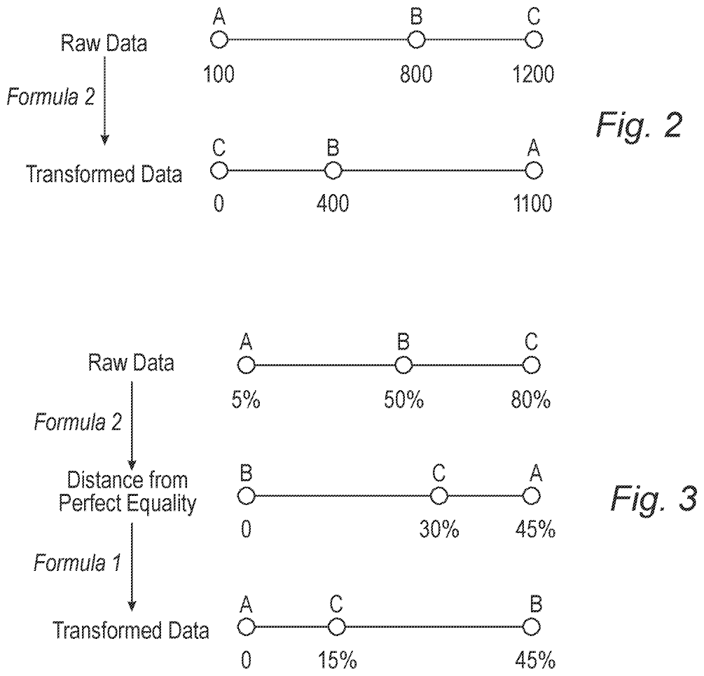

The new version of the X variable can be interpreted as a positively correlated figure of merit, with higher values indicating better performance. This technique may be useful, e.g., for creating a metric from greenhouse gas emissions data. Thus, for example, FIG. 2 illustrates a process for scoring greenhouse gas emissions that creates a positive figure of merit. This data may be further linearly or logarithmically scaled in various ways to map the transformed data onto a 0-100 scale for company performance.

For metrics where a particular target value signifies the best company performance, such as gender equality performance, at each point in time, a new metric may be created that corresponds to the absolute value of the distance between the metric's observed values and 0.5 (assuming that 50%=perfect gender equality, although different numbers based on actual population distribution and/or other targets or goals may also or instead be used as will be understood by a skilled artisan). The use of an absolute value treats deviations from the target equally, regardless of direction. That is, a company with 60% female representation on the board will have the same score as a firm with 40% female representation, as both firms are 10 percentage points away from the target value (i.e., if the target value is 50%).

New(X)=|X−50%| [Eq. 2]

The new variable indicating the distance from the target can then be transformed using Eq. 1 above, in order to reverse the effect of deviations from the target on the calculated score. Thus, for example, FIG. 3 illustrates a process for scoring gender equality that creates a positive figure of merit.

By processing raw data 102 in this manner, all ESG metrics for a company can be interpreted the same way, e.g., with consistent figures of merit that provide higher scores for better company performance. These figures of merit may also be scaled to values between 0-100, e.g., using the following transformation:

$$Score ( X ) = \frac{X - min ( X )}{max ( X ) - min ( X )} * 100 \qquad [ Eq . 3 ]$$

It will be noted that minimum and maximum values may be applied for a particular peer group at a particular time. Certain minima and maxima may also be determined based on practical or physical limits such as a minimum greenhouse gas emission of zero (although negative net emissions are theoretically possible) or a maximum human age of one-hundred and five years (although greater ages are also possible). Where X is an array of metric values in each peer group at each point in time, other types of metric transformation may be used instead of a z-scoring approach ([X−mean(X)]/stdev(X)) in order to preserve the underlying distribution of the data within each peer group, at each point in time. The output of Eq. 3 may be a dataset of ESG metric scores ranging from 0-100 within peer groups at any corresponding point(s) in time.

Returning to FIG. 1, the metric scoring 104 described above may yield a number of metric scores 106 indicative of performance on ESG issues and based on the raw data 102 that has been selected using a materiality map. However, there may be different numbers and types of data sources for each issue of interest, and as such, these metric scores 106 may usefully be converted into issue scores that are more directly descriptive of the issues identified, e.g., in a materiality map, as relevant to evaluation of a company's ESG performance. To this end, issue scoring 108 may be performed, e.g., by aggregating various metric scores 106 corresponding to a common issue in the materiality map. In general, these metric scores may be summed up and then rescaled between 0 and 100 using, e.g., Eq. 3. This may be done globally, or this may be done within a particular company peer group and/or at a particular point in time, or some combination of these. In one aspect, all metrics are equally weighting for an issue, although other weightings may also or instead be used, e.g., where one metric is known to be more accurate, more relevant, or some combination of these.

Different material issues can have a different impact on financial performance. While this is true conceptually and is outlined in the literature around ESG financial materiality, the quantitative extent of this difference may depend on the raw data 102 used to measure company ESG performance. As such, the issue scores 110 calculated above may be further analyzed to evaluate actual historical impact on financial performance and valuation in order to perform an issue weighting 112 that yields a number of issue weights 114 for performing an ESG scoring 116 that combines the various issue scores 110 described above into a composite ESG score 118.

In general, the issue weights 114 may represent the relative importance of each material issue scored using the raw data 102 to a composite ESG score 118. To compute these issue weights 114, regression models or other techniques can be used to investigate the relationship between an industry's financial performance and the issue scores 110 over time. For example, for each industry group, a regression model may be run for key financial variables, capital efficiency, and valuation. As a more specific example, a fixed effects panel regression model may be used with dependent variables such as return on equity, return on assets, and a price-to-book ratio, along with the issue scores 110 as independent variables. The model may be controlled for, e.g., market capitalization and any other relevant or potentially relevant factors. In this case, the three dependent variables may be investigated for different magnitudes of impact on drivers of financial performance such as capital efficiency, profitability, valuation, and the like, each of which may be embedded in the dependent variables through the use of corresponding financial metrics.

From each regression output, issue-specific weights may be constructed as follows. For each regression model r, and for each material issue i, if the regression coefficient βr,i>0, then:

$${w}_{r , i} = \frac{1}{N} + α * ln [ 1 + ( \frac{{t}_{r , {i}^{2}}}{{\sum }_{i = 1}^{N} {t}_{r , {i}^{2}}} ) ] \qquad [ Eq . 4 ]$$

If the regression coefficient βr,i≤0, then:

w_{r,i}=0 [Eq. 5]

In Eqs. 4 and 5, N is the total number of industry group material issues, i is the i-th industry group material issue, a is a materiality multiplier determined through scenario testing, and tᵢ² is the squared t-statistic of material issue i, which is extracted from the regression output. Running these regressions, or any other quantitative analyses that models the relationship between issue scores 110 and financial performance, may be used to derive weighting for calculation of an ESG score 118.

Additionally, this type of modeling may provide an empirical basis for verifying ESG issue materiality selections obtained from the materiality map (or other source). While industry-material issues may be identified using a qualitative approach such as the materiality map or other fundamental analysis, the choice and quality of the data used to measure these issues can affect the accuracy or usefulness of their impact on a composite ESG score 118. In order to address potential errors arising from the nature of the source data (or errors in the materiality map), the output from a regression model or similar analysis may be used to refine the list of material issues used to calculate the ESG score 118, and to facilitate filtering of issues and/or sources of raw data 102 that do not appear to contribute to an accurate ESG score 118.

In one aspect, all issues having issue scores 110 with a positive coefficient from the regression analysis may begin with equal weights in the issue weighting 112, and issues with negative coefficients may be excluded from the issue scores 110 used to calculate the aggregated ESG score 118. The remaining issues—i.e., those with positive regression coefficients—may then be adjusted based on the significance of their signal from a given regression model (e.g., where a higher t-statistic signifies a higher confidence in the model's positive coefficient estimate). Separate sets of material issue weights may be produced for each regression model run. The final set of industry-group material issues may be formed from the issues with a positive coefficient in at least one of these regressions. The final set of material issue weights may then be calculated as a blended average of the weights from the different regression models. The final issue weights may then be rescaled so that they sum to 1. In general, the issue weights 114 for a resulting set of issue scores 110 may be industry group-specific and may be fixed over time, subject to a periodic recalibration of issue-weights, e.g., concurrently with an annual update to the materiality map and/or sources of raw data 102. It will be understood that other techniques may also or instead be used to combine and weight scores derived from the various data sources described herein.

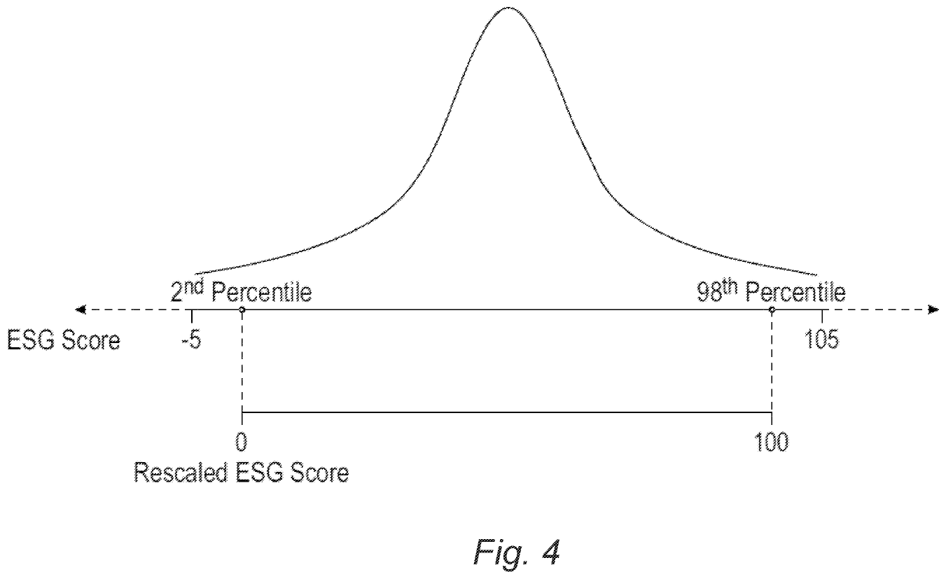

The ESG score 118 may be calculated in an ESG scoring 116 step that computes the ESG score 118 as a weighted average of the issue scores 110 using the (scaled) issue weights 114. In one aspect, outliers may usefully be removed, clipped, winsorized, or otherwise fitted to other data in a distribution in order to reduce their impact on the final distribution of scores. For example, companies in a top and bottom tail of a scoring distribution may be assigned a value within a few standard deviations of the mean, or otherwise windowed, removed, or adjusted to avoid inappropriately skewing other data. FIG. 4 shows a distribution of scores that has been adjusted in this manner to account for outliers.

In one aspect, ESG scoring 116 may be performed relative to a peer group. In this case, the ESG score 118 provides a quantitative representation of a company's ESG performance relative to the relevant peer group. However, the selection of an appropriate peer group may vary under certain circumstances. For example, while risk exposure to environmental and social issues may depend on an industry of operation, good governance may instead depend on the regulatory environment rather than the industry. For this reason, when scoring environmental and social issues, the peer group may be defined as the company's primary industry group (e.g., a Global Industry Classification Standard (GICS) industry group). On the other hand, when scoring governance issues, the peer group may be defined as the company's region of primary operation, determined by the company's country of incorporation. Where a category for a company is hierarchically defined, e.g., using the GICS classification system, the level selected for a peer group may be based on the quantity and quality of underlying data for ESG issues. For example, environmental and social scoring may advantageously be carried out at the (e.g., GICS) industry group level instead of at the more granular industry level when the size of the common universe of companies scored by both Sustainalytics and Bloomberg does not lead to enough industry representation for scoring purposes. For example, given a sample of companies scored by both providers, some industries may include as little as two companies, limiting the value or significance of a ranking scaled between 0-100 for those companies. The same general technique may be used when selecting a hierarchically defined geographic scope, e.g., by flexibly selecting between regions, countries, and states when scoring governance issues.

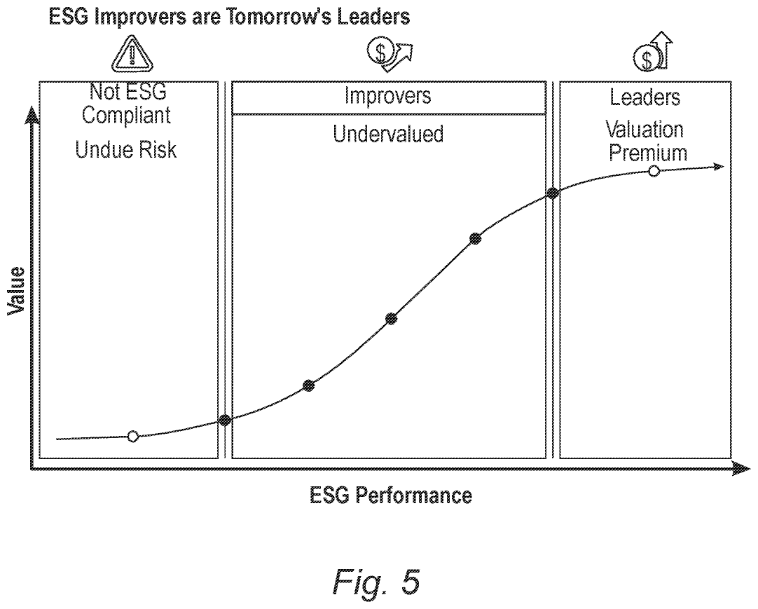

FIG. 5 illustrates companies that are undervalued based on improving trends in ESG issues. In general, companies that have low ESG scores will tend to receive a valuation discount based on perceived or actual risks due to poor ESG performance. Conversely, companies with high ESG scores will tend to receive a valuation premium based on perceived or actual benefits due to good ESG performance. In the middle region, companies will receive neutral valuations based on average ESG performance as reflected in average ESG scores. However, this static analysis can overlook an important consideration. When the ESG score is improving over time for a company, that company can be expected to enjoy a growing valuation premium independent of financial trends as the company's attention to various issues captured in the ESG score yields improvements in governance, regulatory compliance, and the like. By identifying these “improvers” that have an increasing ESG score, it is possible to identify companies that are undervalued relative to their peers, and that are expected to enjoy higher future valuations relative to underlying financial metrics in the form of higher earnings multiples and the like.

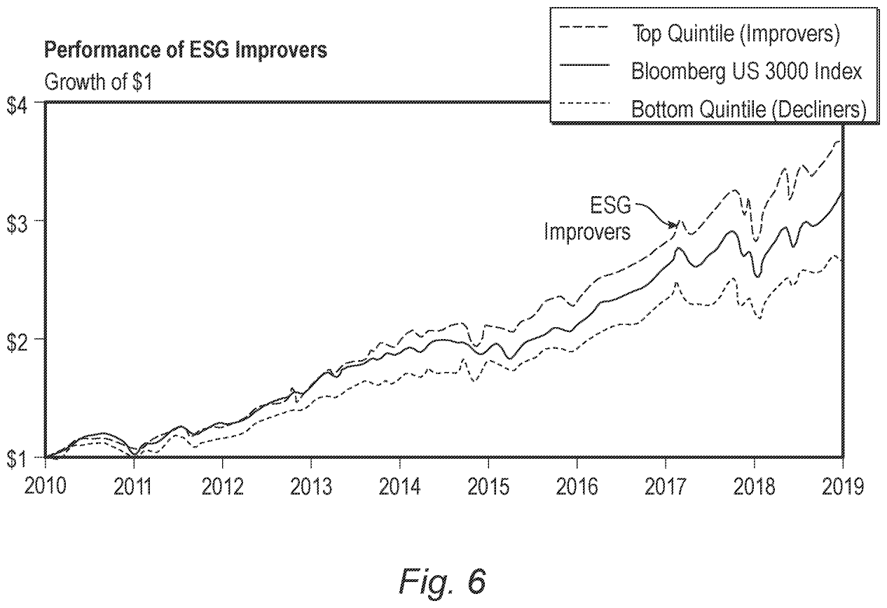

This premise has been back tested on quarterly time series data using raw data from commercially available sources such as Bloomberg and Sustainalytics, and demonstrated to yield significant performance gains, consistently in excess of fifty basis points of alpha that cannot be explained by other financial variables when using an ESG score as a factor in portfolio composition. For example, FIG. 6 illustrates ten year performance of a top quintile of ESG improvers relative to the Bloomberg US 3000 index and the bottom quintile of ESG improvers (which might more accurately be referred to as ESG decliners), where the top quintile of ESG improvers (rebalanced quarterly) generated an excess return of 1.5% over the Bloomberg US 3000 index.

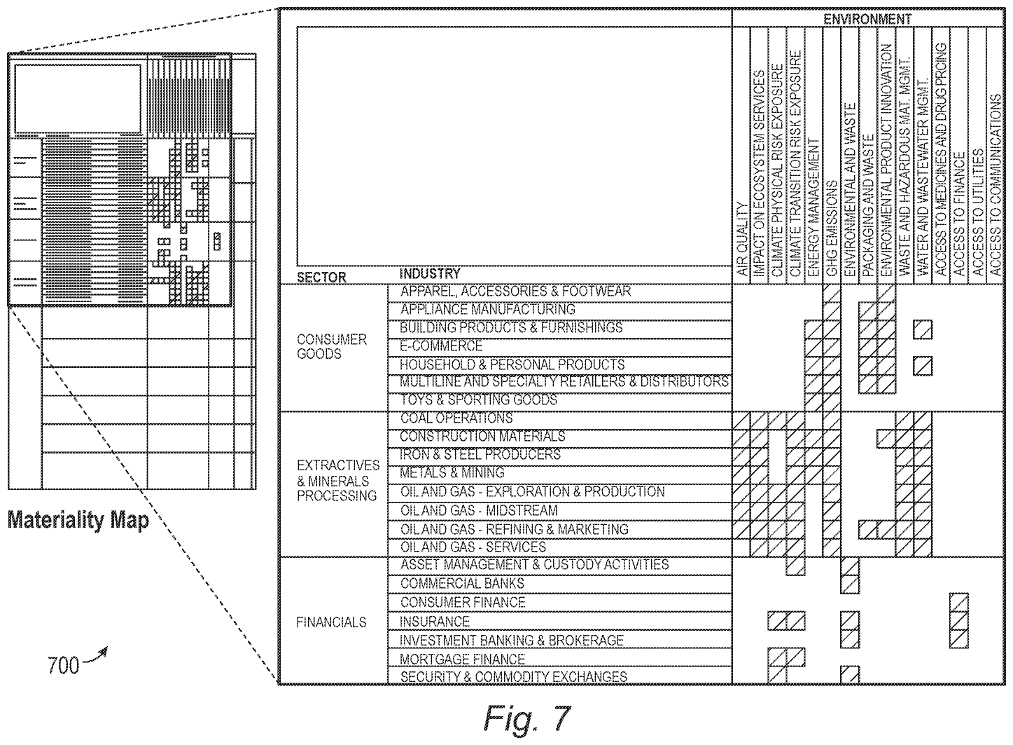

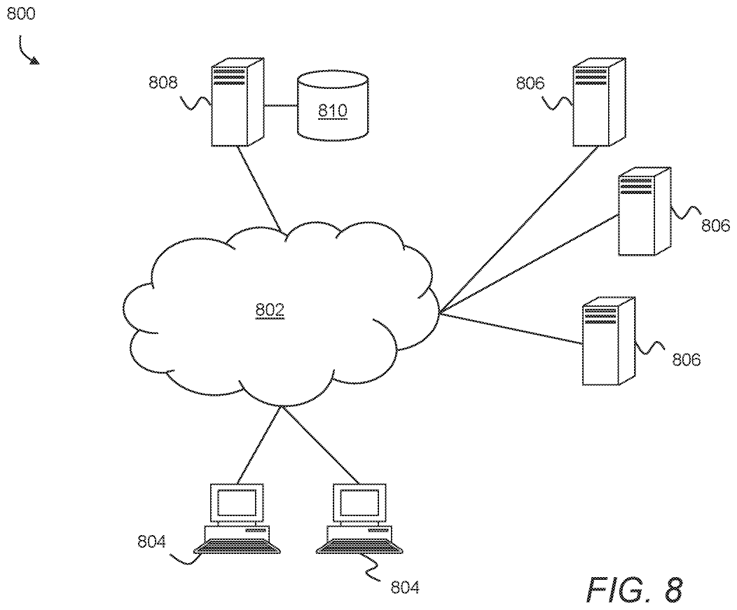

FIG. 7 illustrates a materiality map 700. As noted above, the selection of raw data for an ESG score may be based on a materiality map 700, which may indicate which ESG issues are relevant to ESG performance on a sector-by-sector basis, and industry-by-industry basis, or some combination of these. The materiality map 700 may, in general, be manually curated, automatically curated, or some combination of these. A representation of the materiality map 700 may be stored in a memory of a computer using any data structure or combination of data structures suitable for use by one or more processors in selecting sources of raw data 102 for use in the method 100 outlined above. Turning back to FIG. 7, a number of structural details of the materiality map 700, as well as considerations for constructing and using the materiality map 700 and underlying sources of data, are now discussed in greater detail.

In general, the material ESG issues contained in the materiality map 700 may be any issues related to performance of a company on environmental, social, or governance issues. Thus, while FIG. 7 illustrates a portion of a materiality map 700, the materiality map 700 may more generally include issues relating to air quality, climate physical risk, climate transition risk, customer privacy and data security, diversity and inclusion, labor rights management, talent attraction and retention, executive compensation, board independence, and so forth, all of which may be hierarchically organized into categories (e.g., environmental, social, governance) and sub-categories. As illustrated in the rows of the materiality map 700, the materiality map 700 may also or instead be organized into sectors such as consumer goods, financials, and so forth, and each such sector may be further divided into specific industries, which may generally be at any level of granularity suitable for modeling as described herein. Each industry may in turn be associated with each of the ESG issues and sub-issues described herein. While these relationships are depicted in a grid, for which a score may be entered at each intersection of an industry and a particular ESG issue, any data structure suitable for capturing quantitative data for relationships among issues and industries may be used as a materiality map as described herein.

In general, the materiality map 700 may score each issue for each industry on a binary scale (material or not material) or on a discrete or continuous numerical scale indicating the relative importance of the issue to the industry. A variety of human, automated, or semi-automated techniques may be used to score each issue-industry category, and/or to track or normalize such scoring over time. A general ESG relevance (e.g., low, medium, high) may also be calculated for each industry, and used to adjust scores in the materiality map and/or facilitate weighting of ESG metrics as described above when calculating an ESG score for a publicly traded security or other company.

Each issue (or sub-category of an issue) in the materiality map 700 may be associated with one or more sources of data in order to facilitate calculation of ESG scores as described herein. Sustainalytics and Bloomberg are commercial data providers that currently provide suitable financial and ESG data for ESG scoring, any of which may be associated with one or more of the categories or sub-categories of issues in the materiality map 700. However, any other provider of relevant data may also or instead be used. Companies that are not publicly traded and/or that do not have appropriate fundamental data disclosure may be excluded from the analysis. In some instances, non-public companies may also or instead be scored, e.g., where similarly consistent and reliable information is available. In one aspect, financial data may be obtained from FactSet. In general, the financial data and ESG data from Sustainalytics are monthly while Bloomberg provides ESG data when a company releases its corporate social responsibility (“CSR”) report, typically although not necessarily on an annual schedule. The frequency and timing of ESG scoring updates as described herein may be adapted to the availability of updates to data from these various sources. It will be appreciated that other data sources are available, and that any such data source that is suitably reliable and accurate may also or instead be used as a source of ESG and/or financial information for ESG scoring of companies of interest.

To obtain the merged dataset with financial and ESG metrics, the underlying data sources may be selected to ensure that data for all relevant financial and ESG metrics are available, and are reported with a frequency and accuracy suitable for generating quality results using the techniques described herein. Where a particular company lacks any data coverage for any financial or ESG metric(s), the company may be removed from the universe of publicly traded securities that are scored using the techniques described herein.

In one aspect, the materiality map 700 may be based on the Sustainable Industry Classification System (SICS). However, other classification systems such as the Global Industry Classification Standard (GICS) (developed by MSCI and Standard & Poor's) are known in the art. Where data sources are classified using one of these alternative taxonomies (or where a useful data source was historically classified using such a taxonomy), a mapping may be created in order to align financial data for different classification schemes within the materiality map 700 and/or to support back-testing of financial performance.

It will also be understood that these classification systems are typically hierarchical in nature. For example, the GICS classification system includes sectors, industry groups within sectors, industries within each industry group, and sub-industries within each industry. To score at a level such as the industry group level, the materiality map 700 may be collapsed from the industry level to the industry group level. This can increase the accuracy of scoring, such as where the sample size of companies in certain industries is too small. It should be noted that an issue may only be material for a subset of industries within each industry group, making the definition of industry group materiality less straightforward. To address this, one or more rules may be established for systematically relating industry materiality to industry group materiality, or vice versa, so that a suitable data set can be consistently selected and applied. Thus, for example, an issue may be considered material for an industry group if the issue is material for at least 50% of the underlying industries in the materiality map. Alternatively, where materiality is highly dependent on the particular industry within an industry group but analysis is not being performed and the industry level, the industry may be treated as an industry group within the hierarchy for purposes of analysis, or the corresponding issue may be excluded from ESG scoring.

In one aspect, using raw data for an ESG issue may lead to size biases in the final ESG score, as some raw data can be correlated with firm size. To avoid such bias, metrics in the source data may be scaled according to company size where possible and/or helpful. For example, data such as the Bloomberg raw ESG metrics may be scaled by firm revenues whenever the observed correlation between the ESG metric and the revenue (or some other measure of size) is higher than 0.5. This process is preferably unsupervised, as the intention is to address a size bias only if the data objectively shows one. Depending on the data and sample at hand, ex-ante analyst judgement on which metrics need rescaling may lead to the creation of a reverse size bias if size and ESG metrics do not in fact exhibit correlation in the data.

While the materiality map 700 will generally identify one or more data sources for each ESG issue that are available from commercial data providers, it may also be necessary or helpful in some circumstances to impute historical data for ESG scoring. For example, imputation may usefully be performed when a time series of ESG data for a company is not complete, or when a time series of ESG data for companies grouped by industry group is completely empty. This is a particularly salient problem for ESG data that has only recently received significant attention from the investment community, and for which the frequency and type of data varies widely among data providers and, even for a single provider, evolves over time. A variety of imputation strategies may be used to address missing or inconsistent data.

In one aspect, one or more data points in a time series may be missing. In this case, linear interpolation may be used to infer missing data points around/between observed data in a time sequence of data. For example, if data is available for at least two months (or two years, for annually reported data) in the time series of a company, the remaining months data may be approximated using linear interpolation. This process may be carried out for ESG data from commercial providers such as Sustainalytics and Bloomberg, as well as for other financial data with missing observations.

In another aspect, a metric or a time interval may have a completely empty time series. In this case, a supervised machine learning algorithm or similar technique may be used to impute data for the intervals or metrics having a completely empty time series. For example, a random forest algorithm may be used to impute data based on suitable imputation groups, suitable metrics, and suitable metric predictors.

With respect to imputation groups, companies that have completely empty data sets for one or more ESG issues (e.g., one or more columns in the materiality map) may be grouped by industry. Since ESG performance is largely peer group dependent, the imputation may be limited to data for companies in the same peer group, which may be defined as the company's industry group, or using any other suitable grouping or the like. While more granular classifications exist, and may be used to characterize various companies, it will be understood that more granular classifications should generally be avoided where the resulting sample sizes become so small that they impair machine learning based imputation.

With respect to suitable metrics, a selection of metrics to be imputed may usefully be limited according to the quality or quantity of available data, or according to any other relevant criteria. In general, the higher the ratio of missing-to-observed values, the less reliable the outcome of the imputation. Thus, for example, to decide which metrics to impute for each industry group, metrics may be limited to those with at least 40% observed values, setting a maximum ratio of imputed-to-observed values at 1.5. While there is no pre-determined rule for setting this threshold, the choice may be informed by the extent of missing values, the goal of imputation, and the imputation method, as well as observation or analysis based on the underlying coverage of observed values. In one aspect, the selection of imputation metrics may be made independently of the materiality map, and independently of any inferences that might be drawn from the map about the potential relevance of a particular metric or category of issue. This approach can help to ensure that the selection of metrics for imputation is based on the nature of and coverage of the underlying metric data and free from other potential selection biases.

With respect to predictors, it will be appreciated that predictive metrics used to inform the approximation of missing values may generally be chosen from available ESG and financial metrics, as well as other metrics where they are known or believed to be relevant. Once all companies are grouped by industry group, a number of criteria may be used for selecting metrics in a predictor (training set) matrix. For example, one criterion may be whether a data set for a metric is complete (e.g., no missing values in a relevant time series). Another useful criterion may be that data for the metric has a non-zero variance, e.g., so that the predictor provides meaning information to the imputation process. Another criterion may be the degree of correlation with other predictors. Preferably, a selected predictive metric will not introduce multicollinearity issues during imputation. To mitigate multicollinearity in a predictor set, principal component analysis may be used to convert an original predictor into a set of orthogonal predictors so that the resulting, transformed predictors are uncorrelated, while retaining maximum variance of the original predictor projected onto the orthonormal basis of the transformed predictors.

FIG. 8 shows a system for evaluating ESG trends. The system 800 may include a data network 802 such as the Internet that interconnects any number of clients 804, data sources 806, and servers 808 (each of which may include a database 810 and/or a database 810 may otherwise be present in the system 800). In general, the server 808 may obtain data from the various data sources 806 and provide a user interface to clients 804 for creating and using models based on data from the data sources 806.

The data network 802 may include any network or combination of networks suitable for interconnecting other entities as contemplated herein. This may, for example, include the Public Switched Telephone Network, global data networks such as the Internet and World Wide Web, cellular networks that support data communications (such as 3G, 4G, 5G, and LTE networks), local area networks, corporate or metropolitan area networks, wide area wireless networks and so forth, as well as any combination of the foregoing and any other networks suitable for data communications between the clients 804, data sources 806 and the server 808.

The clients 804 may include any device operable by end users to interact with the servers 808 and data sources 806 through the data network 802. This may, for example, include a desktop computer, a laptop computer, a tablet, a cellular phone, a smart phone, and any other device or combination of devices similarly offering a processor and communications interface collectively operable as a client device within the data network 802. In general, a client 804 may interact with the server 808 and locally render a user interface such as a web page or the like for a user to access services hosted by the server 808. This may include a variety of data analytics and data management tools, as well as administrative tools for creating accounts, controlling access to data, and so forth. The servers 808 may also support interaction by an end user with the data sources 806 or related services provided by the server 808.

The data sources 806 may include any sources of data related to the creation of the materiality map or the identification and use of raw data for creating ESG scores and the like. The data sources 806 may, for example, include commercial providers of financial data and ESG data for publicly traded companies such as Bloomberg, Sustainalytics, and FactSet. It will be appreciated that, in general, such data may be stored in the data sources 806 remote from one of the servers 808, or retrieved and stored in a database 810 (e.g., local to one of the servers 808), or some combination of these, all of which are generally referred to herein as a database. In general, the physical and logical arrangement of such a database 810 may be in any form, and one of the servers 808 may provide a seamless interface to such data in any suitable format.

The server 808 may include any number of physical or logical machines according to a desired level of service, scalability, processing power or any other design parameters. In general, the server 808 may be configured to gather data from data sources 806 and process the data to create and apply models such as those contemplated herein. In addition, the server 808 may provide a programming interface for creating and modifying models, a user interface for using the models, and an administrative interface for managing models, data, data access, user accounts, and so forth, as well as any other tools or interfaces suitable for creating or interacting with models as contemplated herein. In one aspect, the server 808 may include a number of separate functional components (which may be similarly logically or physically separated, or embodied in a single machine) such as one server coupled to the data sources 806 for managing communications therewith, such as through an application or database programming interface, a second server that provides a user interface to clients 804, and a third server that provides statistical engines and the like for creating and using models based on the data.

The database 810 may store any of the raw or processed data described herein. For example, the database 810 may store a computer representation of the materiality map. The database 810 may also or instead store raw data used to populate data sets for issues and companies identified in the materiality map. In another aspect, the database 810 may store weights, models, and other data used to generate ESG scores for companies from the raw data. In another aspect, the database 810 may store historical price data used for back-testing or other analysis using ESG trend information. More generally, the database 810 may store any of the data or data structures described herein and useful for identifying and applying ESG performance trends or other similar historical trends related to company performance.

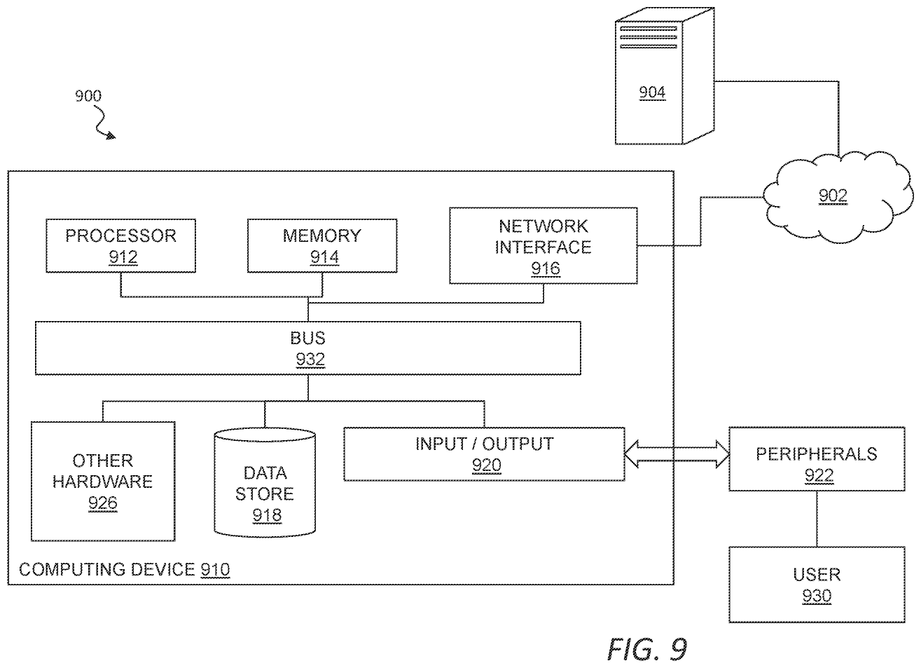

FIG. 9 illustrates a computer system 900. In general, the computer system 900 may include a computing device 910 connected to an external device 904 through a network 902. The computing device 910 may be or may include any of the network entities described herein including data sources, servers, client devices, and so forth. For example, the computing device 910 may include a desktop computer workstation. The computing device 910 may also or instead be any device suitable for interacting with other devices over a network 902, such as a laptop computer, a desktop computer, a personal digital assistant, a tablet, a mobile phone, a television, a set top box, a wearable computer, and the like. The computing device 910 may also or instead include a server such as any of the servers described above. The computing device 910 may be a standalone physical device, a device integrated into another entity or device, a platform distributed across multiple entities, or a virtualized device executing in a virtualization environment.

The network 902 may include any of the networks described herein, e.g., data network(s) or internetwork(s) suitable for communicating data and control information among participants in the computer system 900.

The external device 904 may be any computer or other remote resource that connects to the computing device 910 through the network 902. This may include any of the servers or data sources described above, as well as any other peer device, client device, server device, network resource, or other device or combination of devices that might usefully be connected in a communicating relationship with the computing device 910 through the network 902.

In general, the computing device 910 may include a processor 912, a memory 914, a network interface 916, a data store 918, and one or more input/output interfaces 920. The computing device 910 may further include or be in communication with peripherals 922 and other external input/output devices that might connect to the input/output interfaces 920.

The processor 912 may be any processor or other processing circuitry capable of processing instructions for execution within the computing device 910 or computer system 900. The processor 912 may include a single-threaded processor, a multi-threaded processor, a multi-core processor and so forth, as well as combinations of these. The processor 912 may be capable of processing instructions stored in the memory 914 or the data store 918.

The memory 914 may store information within the computing device 910. The memory 914 may include any volatile or non-volatile memory or other computer-readable medium, including without limitation a Random-Access Memory (RAM), a flash memory, a Read Only Memory (ROM), a Programmable Read-only Memory (PROM), an Erasable PROM (EPROM), registers, and so forth. The memory 914 may store program instructions, program data, executables, and other software and data useful for controlling operation of the computing device 910 and configuring the computing device 910 to perform functions for a user. The memory 914 may include a number of different stages and types of memory for different aspects of operation of the computing device 910. For example, a processor may include on-board memory and/or cache for faster access to certain data or instructions, and a separate, main memory or the like may be included to expand memory capacity as desired. All such memory types may be a part of the memory 914 as contemplated herein.

The memory 914 may, in general, include a non-volatile computer readable medium containing computer code that, when executed by the computing device 910 creates an execution environment for one or more computer programs including, e.g., code that constitutes processor firmware, a protocol stack, a database management system, an operating system, or a combination of the foregoing, and that performs some or all of the steps set forth in the various flow charts and other algorithmic descriptions set forth herein. While a single memory 914 is depicted, it will be understood that any number of memories may be usefully incorporated into the computing device 910. For example, a first memory may provide non-volatile storage such as a disk drive for permanent or long-term storage of files and code even when the computing device 910 is powered down. A second memory such as a random-access memory may provide volatile (but higher speed) memory for storing instructions and data for executing processes. A third memory may be used to improve performance by providing higher speed memory physically adjacent to the processor 912 for registers, caching and so forth.

The network interface 916 may include any hardware and/or software for connecting the computing device 910 in a communicating relationship with other resources through the network 902. This may include remote resources accessible through the Internet, as well as local resources available using short range communications protocols using, e.g., physical connections (e.g., Ethernet), radio frequency communications (e.g., Wi-Fi), optical communications, (e.g., fiber optics, infrared, or the like), ultrasonic communications, or any combination of these or other media that might be used to carry data between the computing device 910 and other devices. The network interface 916 may, for example, include a router, a modem, a network card, an infrared transceiver, a radio frequency (RF) transceiver, a near field communications interface, a radio-frequency identification (RFID) tag reader, or any resource for transceiving data or otherwise managing communications with other devices.

The data store 918 may be any internal memory store providing a computer-readable medium such as a disk drive, an optical drive, a magnetic drive, a flash drive, or other device capable of providing mass storage for the computing device 910. The data store 918 may store computer readable instructions, data structures, program modules, and other data for the computing device 910 or computer system 900 in a non-volatile form for relatively long-term, persistent storage and subsequent retrieval and use. For example, the data store 918 may store an operating system, application programs, program data, databases, files, and other program modules or other software objects and the like.

The input/output interface 920 may support input from and output to other devices that might couple to the computing device 910. This may, for example, include serial ports (e.g., RS-232 ports), universal serial bus (USB) ports, optical ports, Ethernet ports, telephone ports, audio jacks, component audio/video inputs, HDMI ports, and so forth, any of which might be used to form wired connections to other local devices. This may also or instead include an infrared interface, RF interface, magnetic card reader, or other input/output system for wirelessly coupling in a communicating relationship with other local devices. It will be understood that, while the network interface 916 for network communications is described separately from the input/output interface 920 for local device communications, these two interfaces may be the same, or may share functionality, such as where a USB port is used to attach to a Wi-Fi accessory, or where an Ethernet connection is used to couple to a network attached storage device.

The peripheral 922 may include any device used to provide information to or receive information from the computing device 900. This may include human input/output (I/O) devices such as a keyboard, a mouse, a mouse pad, a track ball, a joystick, a microphone, a foot pedal, a camera, a touch screen, a scanner, or other device that might be employed by the user 930 to provide input to the computing device 910. This may also or instead include a display, a speaker, a printer, a projector, a headset, or any other audiovisual device for presenting information to a user. The peripheral 922 may also or instead include a digital signal processing device, an actuator, or other device to support control of or communication with other devices or components. Other I/O devices suitable for use as a peripheral 922 include haptic devices, three-dimensional rendering systems, augmented-reality displays, and so forth. In one aspect, the peripheral 922 may serve as the network interface 916, such as with a USB device configured to provide communications via short range (e.g., Bluetooth, Wi-Fi, Infrared, RF, or the like) or long range (e.g., cellular data or WiMax) communications protocols. In another aspect, the peripheral 922 may augment operation of the computing device 910 with additional functions or features, such as a global positioning system (GPS) device, a security dongle, or any other device. In another aspect, the peripheral 922 may include a storage device such as a flash card, USB drive, or other solid-state device, or an optical drive, a magnetic drive, a disk drive, or other device or combination of devices suitable for bulk storage. More generally, any device or combination of devices suitable for use with the computing device 900 may be used as a peripheral 922 as contemplated herein.

Other hardware 926 may be incorporated into the computing device 900 such as a co-processor, a digital signal processing system, a math co-processor, a graphics engine, a video driver, a camera, a microphone, speakers, and so forth. The other hardware 926 may also or instead include expanded input/output ports, extra memory, additional drives (e.g., a DVD drive or other accessory), and so forth.

A bus 932 or combination of busses may serve as an electromechanical backbone for interconnecting components of the computing device 900 such as the processor 912, memory 914, network interface 916, other hardware 926, data store 918, and input/output interface 920. As shown in the figure, each of the components of the computing device 910 may be interconnected with a system bus 932 and coupled in a communicating relationship through the system bus 932 for sharing controls, commands, data, power, and so forth.

Methods and systems described herein can be realized using the processor 912 of the computer system 900 to execute one or more sequences of instructions contained in the memory 914 to perform predetermined tasks. In embodiments, the computing device 900 may be deployed as a number of parallel processors synchronized to execute code together for improved performance, or the computing device 900 may be realized in a virtualized environment where software on a hypervisor or other virtualization management facility emulates components of the computing device 900 as appropriate to reproduce some or all of the functions of a hardware instantiation of the computing device 900.

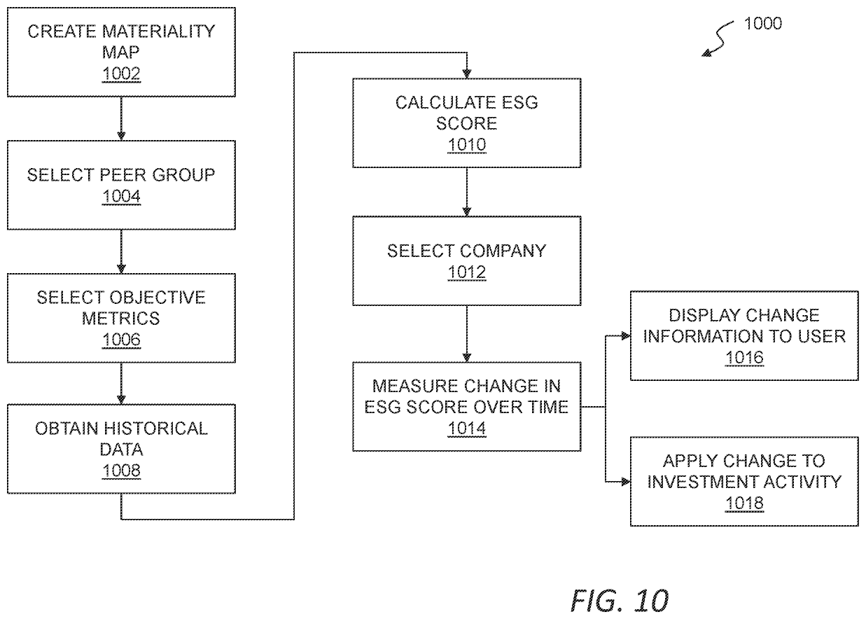

FIG. 10 shows a method for evaluating ESG performance trends. In general, the method 1000 may include using a materiality map such as any of those described above to select time series data sources for scoring a company. The data may then be scored using, e.g., the techniques described in FIG. 1, resulting in a time-based ESG score for a company. A pattern of change in the ESG score over time may be displayed to a user, applied to make automated or computer-assisted investment decisions, or otherwise used to analyze one or more companies based on trends in ESG performance.

As shown in step 1002, the method 1000 may include creating a materiality map. This may, for example, include any of the materiality maps described herein, which may be stored using any suitable data structure(s) in a database of a server or in any other memory where the materiality map can be used as contemplated herein. The materiality map may generally characterize the importance of various ESG issues to different types of companies. The ESG issues may be hierarchically categorized, and the materiality map may identify various sources of data for each ESG issue identified in the materiality map. Similarly, the company types may be hierarchically categorized, and the materiality map may identify a particular type within the hierarchy for companies within the categories mapped by the materiality map.

As shown in step 1004, the method 1000 may include selecting a peer group for analysis. In general, ESG scores for a company as contemplated herein are based on a comparison to a group of relevant peers, such as industry peers or sector peers. In principle, it is possible to receive a user input of a particular company and then use an associated GICS category along with the materiality map to guide a selection of peers and data sources which may then be processed to derive ESG scores. However, this ESG scoring is typically complex and computationally expensive. Against this backdrop, it may be advantageous, particularly where users might expect real time or near real time reporting of ESG scoring trends, to pre-process ESG scores for an entire peer group and store resulting time series ESG score data for the companies in the peer group. With the data processed and stored in this manner, ESG scoring data and ESG improvement data can be quickly provided as needed, for example in response to a user request for data on a particular company as shown in step 1012 below.

As shown in step 1006, the method 1000 may include selecting a number of objective metrics for creating a score to evaluate the company on environmental, social, and governance issues. The selection of objective metrics may be guided by the materiality map, which identifies one or more environmental, social, and governance issues relevant to an industry for the company, and which also identifies one or more sources of data for each such ESG issue. The objective metrics may, for example, include any of the quantitative measures of performance on ESG issues for which historical data is available, such as the quantitative time series data described above and available from commercial providers such as Bloomberg and Sustainalytics. The process of identifying and selecting these data sources is described in greater detail above.

As shown in step 1008, the method 1000 may include obtaining historical data for the number of objective metrics from one or more commercial data providers. This historical data may, for example, include any of the raw data described above with reference to FIG. 1, or any other historical, time series data useful for scoring a company on ESG issues as described herein. In general, this historical data may be pre-processed, e.g., to create metrics with a more uniform, positive correlation to good ESG performance. A variety of pre-processing techniques for transforming, normalizing, combining, and scaling raw data into metric scores are described above. For example, this may include normalizing all of the objective metrics to be a figure of merit positively correlated to more favorable performance in the industry for the company. It will be understood that, while this type of pre-processing is described with reference to step 1008, pre-processing may also or instead be performed in step 1010, or at any other step in the method 1000 described herein. In another aspect, obtaining historical data may include imputing data where time series data is partially or wholly absent for a company, e.g., using any of the imputation techniques described above.

As shown in step 1010, the method 1000 may include calculating an ESG score for the selected company. In general, this may include calculating the score at a number of different times, e.g., based on the historical data, and at any suitable frequency and over any suitable span of time supported by the historical data and/or requested by a user. This may, for example, including metric scoring, issue scoring, issue weighting, and ESG scoring as described herein. However, other steps may also or instead be included in calculating an ESG score. For example, where company size appears inherently correlated to the value of one or more metric scores or issue scores, calculating the ESG score may include scaling one or more of the objective metrics in the score based on a revenue of the company or some other measure of size to counter the effects of size on ESG scoring. As another example, metric scores derived from raw data may be normalized so that they are all figures of merit positively correlated to more favorable ESG performance, and/or scaled so that each metric score contributes equally or appropriately to a composite ESG score. As another example, calculating the score may include weighting one or more of the objective metrics in the score according to a measured relevance of one or more of the objective metrics to a financial performance within a peer group of companies including the company. More generally, any number of filtering, normalization, scaling, pre-processing, post-processing, or other steps or combination of steps may also or instead be used to calculate an ESG score as described herein.

As shown in step 1012, the method 1000 may include selecting a company, such as a company within a peer group that has been pre-processed to generate time series ESG scoring data as described herein. The company may, for example, be entered by a user on a computer such as any of the computing devices described herein, and may be used to retrieve relevant data, perform any needed calculations, and provide data to the user. The company may, for example, be identified by name, by a ticker simple for a public exchange, by a CUSIP or other identifier, or using any other identifier or combination of identifiers useful for uniquely identifying the company among a population of possible companies contained in the materiality map.

As shown in step 1014, the method 1000 may include measuring a change in the score over time. As a significant advantage, the change in this ESG score over time facilitates the identification of companies that have improving ESG performance, and that might reasonably be expected to enjoy an improved premium to underlying financial performance at some future time. This quantitative measure of ESG improvement is derived as explained herein from a complex analysis of issue materiality, data availability, and a variety of techniques for normalization, imputation, and synthesis, which collectively provide an objective, quantitative basis for identifying improvement (and by contrast, decline) in ESG performance by a company relative to industry and sector peers. As described herein, in one aspect the data may advantageously be pre-processed into time series ESG scoring data to facilitate on-demand uses such as display to a user. The resulting ESG improvement scores advantageously provide a new, objective measure of ESG performance of more than a passing academic interest. The ESG score, and more particularly, changes in the ESG score over time, permits the identification of undervalued companies in a manner that has not been previously available, and that can support a demonstrable improvement in investment performance when using ESG improvement as an investment factor.

As shown in step 1016, the method 1000 may include displaying information about changes in the ESG score to a user, e.g., as a quantity, as a graph, as a graphic, or in some other manner. The change may be displayed as an individual quantitative metric for a company, or in the context of ESG performance of other companies, such as by displaying the change to a user in manner that compares the change to a second change calculated for one or more other companies, which may include other companies selected by the user, other companies in a peer group for the company, or some combination of these. The change may also or instead be displayed in the context of change in the ESG performance over time, e.g., in a manner that illustrates whether ESG performance of the company is improving, declining, or remaining the same.

As shown in step 1018, the method 1000 may include applying the ESG score, or more specifically, the change in the ESG score, to investment activity. For example, the change may be applied as a factor in making a decision to purchase or sell shares in the company, either automatically (e.g., by providing the change as an input to a programmatic stock purchasing engine), manually (e.g., by displaying the change to a user to assist in a purchasing decision), or some combination of these. The change may also or instead be used as a factor in a factor-based investment in the company, e.g., by creating or rebalancing a portfolio of companies based on ESG improvement. The change may also or instead be used as a selection criterion for the company in a portfolio, and/or as a factor in weighting the company in a portfolio. In another aspect, applying the change may include identifying the company as undervalued (e.g., when the ESG score is improving) or overvalued (e.g., when the ESG score is declining) based on the change in the score over time. This relative valuation or adjustment to the valuation may also or instead be displayed to a user, either as a standalone company metric or as an adjustment to another company metric. For example, a quantitative metric such as a valuation based on discounted cash flow or enterprise value may be adjusted or scaled according to the change in the ESG score for a company.

Many other uses of an ESG improver score are possible. The ESG score, and more particularly, changes in the ESG score, permit the identification of undervalued companies in a manner that has not been previously available, and that more generally supports a demonstrable improvement in investment performance when using ESG improvement as an investment factor. Thus, for example, ESG improvement may be used as a factor in factor-based investing, either as a standalone factor for portfolio composition or in combination with other investment factors. Thus, for example, a portfolio may be formed of top ESG performers such as the top decile or top quintile of ESG improvers—those with the greatest improvement in ESG score over some window of time—which may be weighted equally, weighted based on ESG score, weighted based on ESG improvement, weighted based on market capitalization, or some combination of these and other factors.

The ESG score, and more particularly the ESG improvement, may be used as a figure of merit for companies. An ESG score, an ESG rank, an ESG grade, and/or an ESG category may be published for companies, and used as a filter for inclusion in, or exclusion from, a list of high quality companies. Where an ESG score can be calculated for a privately-held company, the ESG improver score may also or instead be used as a metric for valuing an initial public offering, a private equity investment, or some other investment. More generally, an ESG improver score that shows the improvement of a company in ESG performance relative to peers and/or the broader market, maybe used as a business metric in its own right, as a weighting mechanism in business valuation or portfolio composition, as an investment filter or criterion, and so forth. Still more generally, an ESG improver score can advantageously be applied in any investment activity or decision that might benefit from an objective indicator of undervaluation, or that might otherwise benefit from information about trends in ESG performance.

According to the foregoing, there is also disclosed herein a system for evaluating ESG performance trends. In general, the system may include a memory, a server, and a scoring engine. The memory may store a materiality that identifies one or more environmental, social, and governance issues relevant to an industry, along with information identifying data sources for raw data supporting ESG scoring. The server may be configured, e.g., by computer executable code stored in a memory and executable by the server (e.g., a processor thereof or in communication therewith) to cause the server to acquire historical data for one or more objective metrics measuring the one or more environmental, social, and governance issues, such as data sources identified in the materiality map. The scoring engine may also be configured by computer executable code stored in a memory and executable by the server to calculate a score to evaluate a company in the industry on the environmental, social, and governance issues by calculating a score at a number of different times based on the historical data, to measure a change in the score over time, and to apply the change as a factor in a factor-based investment in the company. The scoring engine may also or instead be configured to apply the change by displaying a factor-based analysis to a user, and/or to programmatically apply the change by automatically initiating a purchase or sale of stock in the company.

Those skilled in the art will appreciate that the present teachings may be practiced with various computer system configurations, including hand-held wireless devices such as mobile phones or PDAs, multiprocessor systems, microprocessor-based or programmable consumer electronics, minicomputers, mainframe computers, and the like. As described above, the present teachings may be practiced in distributed computing environments where tasks are performed by remote processing devices that are linked through a communications network. In a distributed computing environment, program modules may be located in both local and remote computer storage media including memory storage devices.

Computers typically include a variety of computer readable media that can form part of the system memory and be read by the processing unit. By way of example, and not limitation, computer readable media may comprise computer storage media and communication media. The system memory may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by a processing unit. The data or program modules may include an operating system, application programs, other program modules, and program data. The operating system may be or include a variety of operating systems such as Microsoft Windows®. operating system, the Unix operating system, the Linux operating system, the Xenix operating system, the IBM AIX™. operating system, the Hewlett Packard UX™. operating system, the Novell Netware™. operating system, the Sun Microsystems Solaris™. operating system, the OS/2™. operating system, the BeOS™. operating system, the Macintosh™. operating system, the Apache™. operating system, an OpenStep™ operating system or another operating system of platform.

At minimum, the memory includes at least one set of instructions that are either permanently or temporarily stored. The processor executes the instructions that are stored in order to process data. The set of instructions may include various instructions that perform a particular task or tasks, such as those shown in the appended flowcharts. Such a set of instructions for performing a particular task may be characterized as a program, software program, software, engine, module, component, mechanism, or tool. A computer may include a plurality of software processing modules stored in a memory as described above and executed on a processor in the manner described herein. The program modules may be in the form of any suitable programming language, which is converted to machine language or object code to allow the processor or processors to read the instructions. That is, written lines of programming code or source code, in a particular programming language, may be converted to machine language using a compiler, assembler, or interpreter. The machine language may be binary coded machine instructions specific to a particular computer.

Any suitable programming language may be used in accordance with the various embodiments of the present teachings. Illustratively, the programming language used may include assembly language, Ada, APL, Basic, C, C++, COBOL, dBase, Forth, FORTRAN, Java, Modula-2, Pascal, Prolog, REXX, and/or JavaScript for example. Further, it is not necessary that a single type of instruction or programming language be utilized in conjunction with the operation of the system and method of the present teachings. Rather, any number of different programming languages may be utilized as is necessary or desirable.

In addition, the instructions and/or data used in the practice of the present teachings may utilize any compression or encryption technique or algorithm, as may be desired. An encryption module might be used to encrypt data. Further, files or other data may be decrypted using a suitable decryption module.

The computing environment may also include other removable/nonremovable, volatile/nonvolatile computer storage media. For example, a hard disk drive may read or write to nonremovable, nonvolatile magnetic media. A magnetic disk drive may read from or write to a removable, nonvolatile magnetic disk, and an optical disk drive may read from or write to a removable, nonvolatile optical disk such as a CD ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media is typically connected to the system bus through a removable or nonremovable memory interface.

The processing unit that executes commands and instructions may be a general purpose computer, but may utilize any of a wide variety of other technologies including a special purpose computer, a microcomputer, mini-computer, mainframe computer, programmed microprocessor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID processor, smart chip, or any other device or arrangement of devices capable of implementing the steps of the processes of the present teachings.

It should be appreciated that the processors and/or memories of the computer system need not be physically in the same location. Each of the processors and each of the memories used by the computer system may be in geographically distinct locations and be connected so as to communicate with each other in any suitable manner. Additionally, it is appreciated that each of the processors and/or memories may be composed of different physical pieces of equipment.

A user may enter commands and information into the computer through a user interface that includes input devices such as a keyboard and pointing device, commonly referred to as a mouse, trackball, or touch pad. Other input devices may include a microphone, joystick, game pad, satellite dish, scanner, voice recognition device, keyboard, touch screen, toggle switch, pushbutton, or the like. These and other input devices are often connected to the processing unit through a user input interface that is coupled to the system bus, but may be connected by other interface and bus structures, such as a parallel port, game port or a universal serial bus (USB).

One or more monitors or display devices may also be connected to the system bus via an interface. In addition to display devices, computers may also include other peripheral output devices, which may be connected through an output peripheral interface. The computers implementing the present teachings may operate in a networked environment using logical connections to one or more remote computers, the remote computers typically including many or all of the elements described above.

Various networks may be implemented in accordance with embodiments of the present teachings, including a wired or wireless local area network (LAN) and a wide area network (WAN), wireless personal area network (PAN) and other types of networks. When used in a LAN networking environment, computers may be connected to the LAN through a network interface or adapter. When used in a WAN networking environment, computers typically include a modem or other communication mechanism. Modems may be internal or external, and may be connected to the system bus via the user-input interface, or other appropriate mechanism. Computers may be connected over the Internet, an Intranet, Extranet, Ethernet, or any other system that provides communications. Some suitable communication protocols may include TCP/IP, UDP, or OSI, for example. For wireless communications, communications protocols may include Bluetooth, Zigbee, IrDa or other suitable protocol. Furthermore, components of the system may communicate through a combination of wired or wireless paths.

Although many other internal components of the computer are not shown, those of ordinary skill in the art will appreciate that such components and the interconnections are well known. Accordingly, additional details concerning the internal construction of the computer need not be disclosed in connection with the present teachings.

It should also be readily apparent to one of ordinary skill in the art that the presently disclosed teachings may be implemented in a wide range of industries. The various embodiments and features of the presently disclosed teachings may be used in any combination, as the combination of these embodiments and features are well within the scope of the present teachings. While the foregoing description includes many details and specificities, it is to be understood that these have been included for purposes of explanation only, and are not to be interpreted as limitations of the present teachings. It will be apparent to those skilled in the art that other modifications to the embodiments described above can be made without departing from the spirit and scope of the present teachings. Accordingly, such modifications are considered within the scope of the present teachings as intended to be encompassed by the following claims and their legal equivalent.

From the foregoing, it will be seen that the present teachings are well adapted to attain all the ends and objects set forth above, together with other advantages, which are obvious and inherent to the system and method. It will be understood that certain features and sub-combinations are of utility and may be employed without reference to other features and sub-combinations. This is contemplated and within the scope of the appended claims.

The above systems, devices, methods, processes, and the like may be realized in hardware, software, or any combination of these suitable for a particular application. The hardware may include a general-purpose computer and/or dedicated computing device. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. In another aspect, the methods may be embodied in systems that perform the steps thereof, and may be distributed across devices in a number of ways. At the same time, processing may be distributed across devices such as the various systems described above, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

Embodiments disclosed herein may include computer program products comprising computer-executable code or computer-usable code that, when executing on one or more computing devices, performs any and/or all of the steps thereof. The code may be stored in a non-transitory fashion in a computer memory, which may be a memory from which the program executes (such as random-access memory associated with a processor), or a storage device such as a disk drive, flash memory or any other optical, electromagnetic, magnetic, infrared, or other device or combination of devices. In another aspect, any of the systems and methods described above may be embodied in any suitable transmission or propagation medium carrying computer-executable code and/or any inputs or outputs from same.

It will be appreciated that the devices, systems, and methods described above are set forth by way of example and not of limitation. Absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

The method steps of the implementations described herein are intended to include any suitable method of causing such method steps to be performed, consistent with the patentability of the following claims, unless a different meaning is expressly provided or otherwise clear from the context. So, for example, performing the step of X includes any suitable method for causing another party such as a remote user, a remote processing resource (e.g., a server or cloud computer) or a machine to perform the step of X. Similarly, performing steps X, Y, and Z may include any method of directing or controlling any combination of such other individuals or resources to perform steps X, Y, and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It should further be appreciated that the methods above are provided by way of example. Absent an explicit indication to the contrary, the disclosed steps may be modified, supplemented, omitted, and/or re-ordered without departing from the scope of this disclosure.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the spirit and scope of this disclosure and are intended to form a part of the present teachings as defined by the following claims, which are to be interpreted in the broadest sense allowable by law.

What is claimed is:

1. A computer program product comprising computer executable code embodied in a non-transitory computer readable medium that, when executing on one or more computing devices, performs the steps of:
selecting a number of objective metrics for creating a score to evaluate a company on environmental, social, and governance issues based on a materiality map that identifies one or more environmental, social, and governance issues relevant to an industry for the company;
obtaining historical data for the number of objective metrics from one or more commercial data providers;
calculating the score at a number of different times based on the historical data, wherein calculating the score includes normalizing all of the objective metrics to be a figure of merit positively correlated to more favorable performance in the industry for the company;
measuring a change in the score over time; and
applying the change as a factor in making a decision to purchase or sell shares in the company.

2. The computer program product of claim 1, wherein applying the change includes using the change as a factor in a factor-based investment in the company.

3. The computer program product of claim 1, wherein applying the change includes using the change as a selection criterion for the company in a portfolio.

4. The computer program product of claim 1, wherein applying the change includes weighting the company in a portfolio based on the change.

5. The computer program product of claim 1, further comprising code that, when executed, performs the step of displaying the change to a user on a display.

6. A method, comprising:
selecting a number of objective metrics for creating a score to evaluate a company on environmental, social, and governance issues;
calculating the score at a number of different times;
measuring a change in the score over time; and
applying the change includes using the change as a factor in a factor-based investment in the company.

7. The method of claim 6, wherein applying the change as a factor includes using the change as a selection criterion for the company in a portfolio.

8. The method of claim 6, wherein applying the change as a factor includes weighting the company in a portfolio based on the change.

9. The method of claim 6, wherein applying the change as a factor includes identifying the company as undervalued or overvalued based on the change in the score over time.

10. The method of claim 6, wherein applying the change as a factor includes making a decision to purchase or sell shares in the company based on the change.

11. The method of claim 6, wherein applying the change as a factor includes providing the change as an input to a programmatic stock purchasing engine.

12. The method of claim 6, further comprising displaying the change to a user as one or more of a quantity and a graph.

13. The method of claim 6, further comprising displaying the change to a user in manner that compares the change to a second change calculated for one or more other companies.

14. The method of claim 6, wherein the number of objective metrics are selected from among objective metrics with historical data available from one or more commercial data providers.

15. The method of claim 6, wherein selecting the number of objective metrics includes creating a materiality map that identifies one or more environmental, social, and governance issues relevant to an industry for the company.

16. The method of claim 6, wherein calculating the score includes obtaining historical data for the number of objective metrics and imputing values for one or more of the number of objective metrics.

17. The method of claim 6, wherein calculating the score includes scaling one or more of the objective metrics in the score based on a revenue of the company.

18. The method of claim 6, wherein calculating the score includes normalizing all of the objective metrics to be a figure of merit positively correlated to more favorable performance.

19. The method of claim 6, wherein calculating the score includes weighting one or more of the objective metrics in the score according to a measured relevance of the one or more of the objective metrics to a financial performance within a peer group of companies including the company.

20. A system, comprising:
a memory storing a materiality map that identifies one or more environmental, social, and governance issues relevant to an industry;
a server configured to acquire historical data for one or more objective metrics measuring the one or more environmental, social, and governance issues; and
a scoring engine executing on the server, the scoring engine configured to calculate a score to evaluate a company in the industry on the one or more environmental, social, and governance issues by calculating a score at a number of different times based on the historical data, to measure a change in the score over time, and to apply the change as a factor in a factor-based investment in the company.

21. The system of claim 20, wherein the scoring engine is configured to apply the change by displaying a factor-based analysis to a user.

22. The system of claim 20, wherein the scoring engine is configured to apply the change by automatically initiating a purchase or sale of stock in the company.
